(19) United States
(12) Patent Application Publication
(10) Pub. No.: US 2010/0112281 A1
(43) Pub. Date: May 6, 2010

(54) Protector

(76) Inventors: Masanori Ogawa, Aichi-Ken (JP); Katsumi Terada, Aichi-Ken (JP); Junichi Hasegawa, Aichi-Ken (JP)

Correspondence Address: COOPER & DUNHAM, LLP, 30 Rockefeller Plaza, 20th Floor, NEW YORK, NY, 10112, US

(21) Appl. No.: 11/988,669

(22) PCT Filed: Jun. 6, 2006
(86) PCT No.: PCT/JP2006/311318

§ 371 Date: Jan. 9, 2008

(30) Foreign Application Priority Data
Jul. 12, 2005 (JP) 2005-202374

(51) Int. Cl. B32B 3/10; B32B 3/00

(52) U.S. Cl. 428/131; 428/174

(57) ABSTRACT

The object of the present invention is to protect a member from damage when a part is fit to the member.

To attain the object, in the present invention, a protector 8 consisting of a hole inner side protective section 9, to protect the inside of the part fitting hole 2 of the member, and a surrounding protective section 10, to protect the surroundings of the part fitting hole, is provided, the two sections 9, 10 integrally making up the protector 8.

The protector 8 is fit into the part fitting hole 2, following which a part 12 is fit thereinto.

### FIELD OF THE INVENTION

The present invention relates to a protector to protect the surroundings and inside of a part fitting hole such as the lamp housing fitting hole of an automobile member such as a bumper, and to prevent damage thereto, in the case of fitting a part.

### BACKGROUND OF THE INVENTION

For instance, in a case where lamp housing(s) is (are) attached to the bumper of a car, lamp housing fitting hole(s) is (are) formed at area(s) of the bumper to which the lamp housing(s) is (are) attached, and said lamp housing(s) is (are) fit into said lamp housing fitting hole(s).

### DISCLOSURE OF THE INVENTION

When said lamp housing(s) is (are) fit in to said lamp housing fitting hole(s) by worker(s), the worker(s) should perform, such operations carefully while attaching said lamp housing(s) to said lamp housing fitting hole(s), or the surroundings and inside(s) of said lamp housing fitting hole(s) may be damaged by the hitting of said lamp housing(s) against the surroundings and inside(s) of said lamp housing fitting hole(s). Such careful operations, however, cause a remarkable deterioration in work efficiency, and remarkable delay in time to complete work.

### MEANS TO SOLVE SAID PROBLEM

As a means to solve said problem, the present invention provides a protector 8 to protect the surroundings and inside of a part fitting hole 2 of a member 1, in the case of fitting a part 12 thereinto, said protector 8 consisting of a hole inner side protective section 9 which is inserted into the inside of said part fitting hole 2 to protect the inside of said part fitting hole 2, and a surrounding protective section 10 which covers the outside surroundings of said part fitting hole 2 to protect said surroundings of said part fitting hole 2, said surrounding protective section 10 integrating with said hole inner side protective section 9.

It is preferable that said protector 8 be made of a synthetic resin having a Rockwell hardness of R50 to 150 according to ASTM D785, and further it is preferable that sheet(s) 11 be attached and extended to/from said hole inner side protective section 9 to protect the inside of said part fitting 2 hole from the harness 18 connecting to said part 12 from the inside of said part fitting hole 2.

### EFFECT OF THE INVENTION

### Action

Said hole inner side protective section 9 of said protector 8 is inserted into said part fitting hole 2 and the surrounding protective section 10 of said protector 8 is closely partially or wholly covered on the outside surroundings of said part fitting hole 2.

After said protector 8 is attached to said part fitting hole 2, a part 12 is then fit into said part fitting hole 2. After said part 12 is fit into said part fitting hole 2, the surrounding protective section 10 of said protector 8 is pulled to remove said protector 8 from said part fitting hole 2, leaving said part 12 in said part fitting hole 2.

In a case where said protector 8 is made of a synthetic resin having a Rockwell hardness of R 50 to 150 according to ASTM D785, the molded shape of said protector 8 is adequately held, and when said protector 8 is taken out of said part fitting hole 2, said protector 8 may be easily deformed, resulting in said protector 8 being easily taken out of said part fitting hole 2.

In a case where a harness is connected to said part 12 from the inside of said part fitting hole 2, it is preferable that a sheet 11 be attached and extended to/from said hole inner side protective section 9 to protect the inside of said part fitting hole 2 from said harness 18, said harness 18 being prevented from making direct contact with the inside of said part fitting hole 2 by said sheet 11.

### Effect

In the present invention, in a case where a part is fit into said part fitting hole 2 of a member, the surroundings and inside of said part fitting hole 2 is prevented from being damaged by said part.

### PREFERRED EMBODIMENT TO PRACTICE THE INVENTION

### EXAMPLE 1

FIGS. 1 to 11 show EXAMPLE 1.

As shown in FIG. 1, a pair of lamp housing fitting holes 2, 2 are formed at both sides of the bumper 1 of a car, with a number plate attaching section 3 being settled in the middle of said bumper 1, and each of said lamp housing fitting holes 2 has bottom panel 4 and ribs 5 and so on, as shown in FIG. 2, and a harness conducting hole 7 is formed in said bottom panel's 4 step section, being on the bumper center side.

The protector 8 of the present invention is shown in FIGS. 3 and 4. Said protector 8 consists of a hole inner side protective section 9 which is inserted into the inside of each lamp housing fitting hole 2 of said bumper 1, and a flange shaped surrounding protective section 10 formed at the outside of said hole inner side protective section 9, integrating with said hole inner side protective section 9. Further, a pair of sheets 11, 11 are attached to the inside of said hole inner side protective section 9 of said protector 8 to protect the inside of said lamp housing fitting hole 2 from the harness connected to said lamp housing.

Said protector 8 is preferably made of a thermoplastic synthetic resin having a Rockwell hardness of R50 to 150 according to ASTM D785. In a case where a thermoplastic synthetic resin having a Rockwell hardness of below R50 is used, the molded shape of the resulting protector 8 is not adequately held, while in a case where a thermoplastic synthetic resin having a Rockwell hardness of over R150 is used, the resulting protector 8 is difficult to deform, making it troublesome to take said protector 8 out of said lamp housing fitting hole 2, leaving said lamp housing 12 in said lamp housing fitting hole 2, as below described.

Said thermoplastic synthetic resin includes such as a high density polyethylene (R=50), polypropylene (homopolymer) (R=80˜102), polypropylene(copolymer) (R=65˜96), ABS (R=85˜106), polyamide6 (R=119), polyamide66 (R=120), polyamide46 (R=122), polyamidePA9T (R=118), polyethylene terephthalate (R=111), styrene modified-PPE (R=115˜116), AES (R=102˜109), AAS (R=96˜108), ACS (R=100˜107) and the like, and a polymer alloy of PPE-polyamide6-styrenic elastomer is a preferable thermoplastic resin in view of heat resistance, moldability, strength deformability, and the like.

An inorganic filler such as calcium carbonate, magnesium carbonate, barium sulphate, calcium sulphate, calcium sulfite, calcium phosphate, calcium hydroxide, magnesium hydroxide, aluminum hydroxide, magnesium oxide, titanium oxide, iron oxide, zinc oxide, alumina, silica, diaton earth, dolomite, gypsum, talc, clay, asbestos, mica, glass fiber, carbon fiber, calcium silicate, bentonite, white carbon, carbon black, iron powder, aluminum powder, stone powder, blast furnace slag, fly ash, cement, zirconia powder and the like, a natural fiber such as cotton, hemp, bamboo fiber, coconut fiber, wool silk and the like an organic synthetic fiber such as polyamide fiber, polyester fiber, acrylic fiber, viscose fiber, acetate fiber, vinyl chloride fiber, vinylidene chloride fiber, vinylon fiber, acetate fiber and the likes, an inorganic fiber such as asbestos fiber, glass fiber, carbon fiber, ceramic fiber, metallic fiber, whisker and the like, and an organic filler such as linter, linen, sisal, wood flour, coconut flour, walnut flour, starch, wheat flour and the like may be added to said thermoplastic synthetic resin. Further, a pigment, dye, antioxidant, antistatic agent, crystallization agent, flame retardant, antiflaming agent, insecticide, antiseptic, various waxes, a lubricant, age resister, ultraviolet absorber and the like may be added to said thermoplastic synthetic resin.

Said ingredient can be used singly or two or more kinds of said ingredient can be used together.

Said protector 8 is manufactured by such as vacuum forming, pressure forming, vacuum and pressure forming, press molding, stamping molding injection molding, or the like.

Said sheets 11, 11 are made of a soft type synthetic resin such as polyethylene, polypropylene, polyamide, polyester, polyurethane or the like, or a nonwoven fabric, knit, textile, or the like.

FIG. 5 shows a lamp housing 12 as a part. In said lamp housing 12, lamps 13, 14, 15, 16 and 17 are settled, with a harness 18 being connected to each lamp 13, 14, 15, 16 and 17 to supply electricity thereto.

To fit said lamp housing 12 into said lamp housing fitting hole 2 of said bumper 1, said protector 8 is first attached to said lamp housing fitting hole 2 as shown in FIGS. 7 and 8. As shown in FIGS. 7 and 8, in a case where said protector 8 is attached to said lamp housing fitting hole 2, said hole inner side protective section 9 of said protector 8 is inserted into said lamp housing fitting hole 2 to cover and protect the inside of said hole 2, and said surrounding protective section 10 of said protector 8 closely covers the outside of said surroundings of said hole 2 so as to protect the surroundings of said hole 2. Further, said sheets 11, 11 of said protector 8 each cover the inside of the part of said hole 2 through which said harness 18 passes.

As described above, said protector 8 is fit into said hole 2 of said bumper 1, after which said lamp housing 12 is inserted into said hole 2 over said protector 8 as shown in FIGS. 9 and 10. In this case, said protector 8 prevents the inside or surroundings of said hole 2 from being damaged by said lamp housing 12, harness 18, the hands of workers, tools, and the like.

After said lamp housing 12 is fit into said hole 2 over said protector 8, said protector 8 is taken out of said hole 2 as shown in FIG. 11. When said protector 8 is taken out of said hole 2, said protector 8 easily deforms since said protector 8 is made of a thermoplastic synthetic resin having a hardness of R50 to 150, making it easy to remove said protector 8 from said hole 2.

### EXAMPLE 2

FIGS. 12 to 19 show EXAMPLE 2.

As shown in FIG. 12, the bumper 21 of a car has an air-inlet 22, with a grille 23, shown in 13, being fit into said air-inlet 22, as a separate part.

Two flanges 24A, 24B are each extended along the middle part of the upper edge, and from the right and left side edges to the lower edge of said air-inlet 22 of said bumper 21, each flange 24A, 24B having a plural number of clip holes 25A, 25B.

When said grille 23 is fit into said air-inlet 22 of said bumper 21, a protector 27 as shown in FIGS. 15 and 16 is used to protect the surroundings and inside of said air-inlet 22.

To mold said protector 27 easily, said protector 27 is divided into two parts, a left half part 28 and a right half part 29, said left half part 28 and said right half part 29 each consisting of hole inner side protective sections 30, 31, and surrounding protective sections 32, 33, and reinforcing ribs 34, 35 respectively project from said hole inner side protective sections 30, 31 of said left half part 28 and said right half part 29. From the left and right sides to the lower parts of said surrounding protective sections 32, 33 of said left half part 28 and said right half part 29, reinforcing ribs 36, 37 project from the surrounding protective sections 32, 33 of said left half parts 28 and said right half part 29, with knobs 38, 39, 40 and 41 which project from predetermined parts of said reinforcing ribs 36, 37.

To protect the left and right side edges and lower edge of said air-inlet 22 of said bumper 21 using said protector 27, said left half part 28 is fit to said air inlet 22 from the left side edge to the left half of the lower edge, and said right half part 29 is fit to said air inlet 22 from the right side edge to the right half of the lower edge, as shown in FIG. 17, and in this case the right end of said left half part 28 is lapped under the left end of said right half part 29, and in said lapping part, the reinforcing rib 36 of said left half part 28 is fit under the reinforcing rib 37 of said right half part 29, setting their positions. Further, said left half part 28 and said right half part 29 may be connected together in advance with an adhesive tape.

As described above, said left half part 28 and said right half part 29 of said protector 27 are each fit to said air-inlet 22 of said bumper 21 from the left and right side edges to the lower edge, and if necessary, said hole inner side protective sections 30, 31 of said left half part 28 and said right half part 29 are each fixed to the circumference edge of said air-inlet 22 with an adhesive tape 42.

As described above, said air-inlet 22 of said bumper 21 is protected by said protector 27, and then said grille 23 is fit to said air-inlet 22 from the outside by engaging the plural number of clips 26A, 26B to the clip holes 25A, 25B of said air-inlet 22 of said bumper 21 as shown in FIG. 14, where said clips 26A, 26B project from predetermined parts of the left and right side edges and the lower edge of said grille 23 (said predetermined parts corresponding to parts in which said clip holes 25A and 25B of said flanges 24A and 24B of said air-inlet 22 of said bumper 21 are formed).

After said grille 23 was fit to said air-inlet 22, said right half part 29 and said left half part 28 of said protector 27 are each taken out of said air-inlet 22 as shown in FIG. 19. Said protector 27 is made of the same material as used in the protector 8 of EXAMPLE 1, and accordingly said protector 27 is deformable and easy to remove.

Besides the above described EXAMPLES, the present invention can be applied, for example, in a case where a lamp is fit to a car body, or a door handle is fit to a door.

### POSSIBILITY OF INDUSTRIAL USE

In the present invention, a part fitting hole of a member is protected from damage in a case where a part is fit to said part fitting hole, so that work efficiency is improved.

### BRIEF DESCRIPTION OF THE DRAWINGS

FIGS. 1 to 11 show EXAMPLE 1 of the present invention.

FIG. 1: Front view of one side of a bumper.

FIG. 2: Cross sectional view cutting along A-A in FIG. 1

FIG. 3: Front view of a protector.

FIG. 4: Cross sectional view cutting along B-B in FIG. 3.

FIG. 5: Front view of a lamp housing

FIG. 6: Side view of a lamp housing.

FIG. 7: Front view of one side of the bumper wherein the protector is fit to a lamp housing fitting hole.

FIG. 8: Cross sectional view cutting along C-C in FIG. 7.

FIG. 9: Front view of one side of the bumper wherein the lamp housing is fit to the lamp housing fitting hole.

FIG. 10: Cross sectional view cutting along D-D in FIG. 9.

FIG. 11: Cross sectional view to illustrate removing the protector from the lamp housing fitting hole (cross sectional view to illustrate that the lamp housing has been fit to the lamp housing fitting hole.

FIGS. 12 to 19 show EXAMPLE 2.

FIG. 12: Plan view of a bumper.

FIG. 13: Plan view of a grille

FIG. 14: Cross sectional view of the grille.

FIG. 15: Plan view of a protector.

FIG. 16: Cross sectional view of the protector

FIG. 17: Cross sectional view of the bumper wherein the protector is fit to the bumper.

FIG. 18: Cross sectional view of the bumper wherein the grille is fit to the bumper.

FIG. 19: Cross sectional view of the bumper where the protector is removed from the bumper.

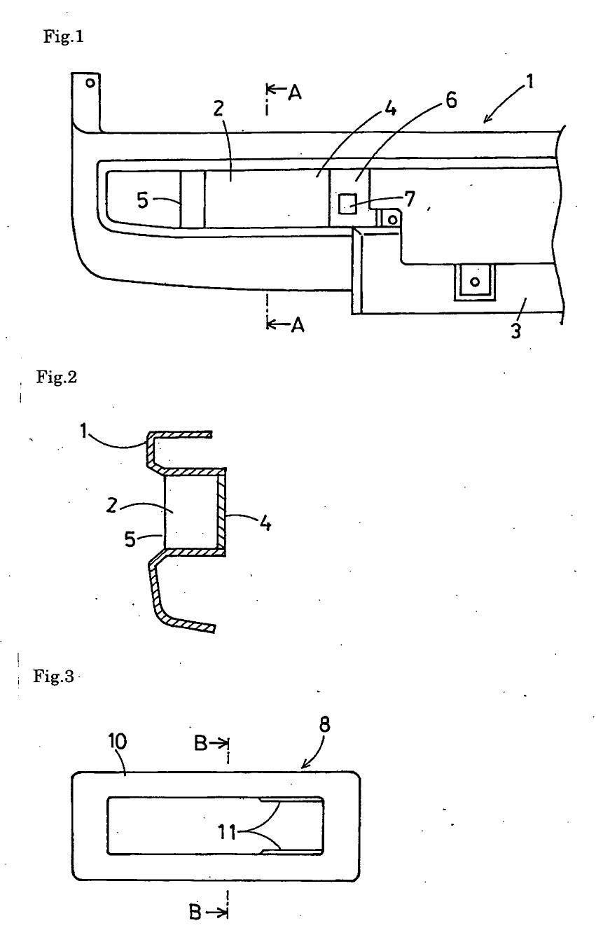

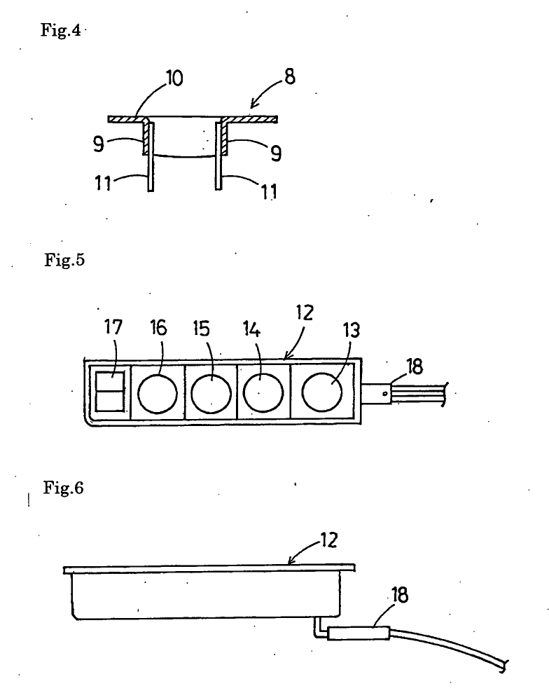

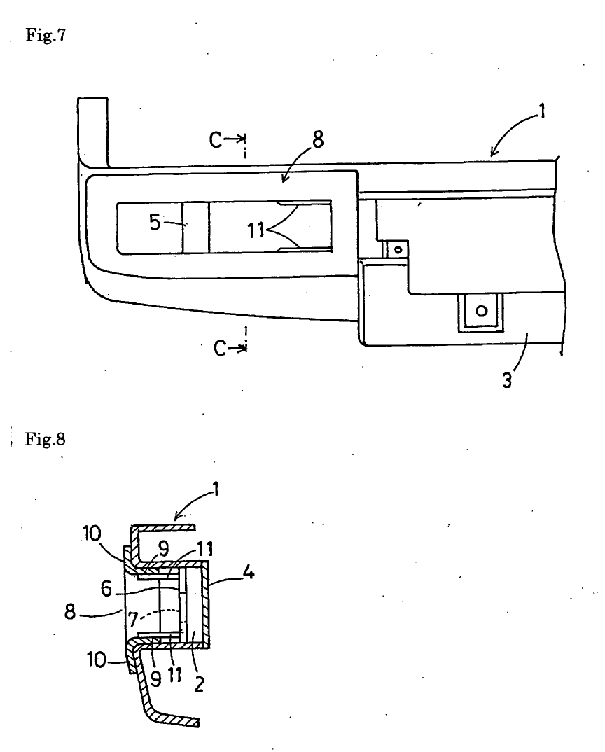

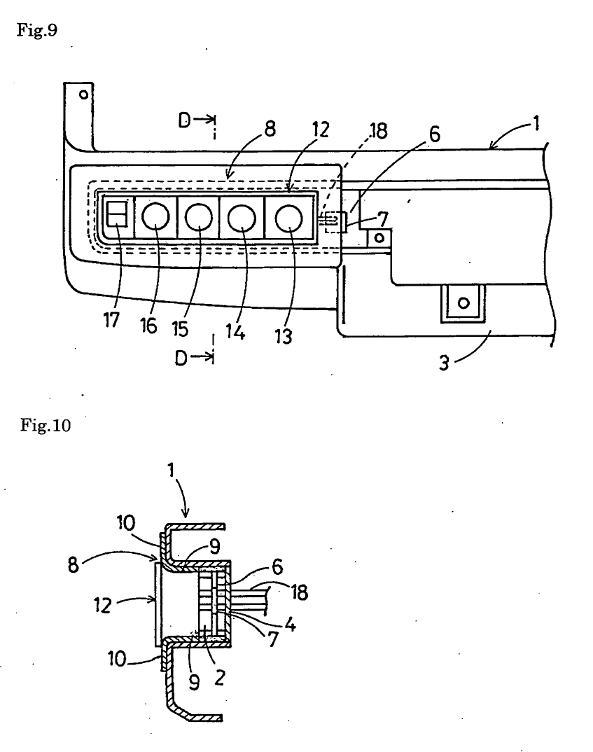

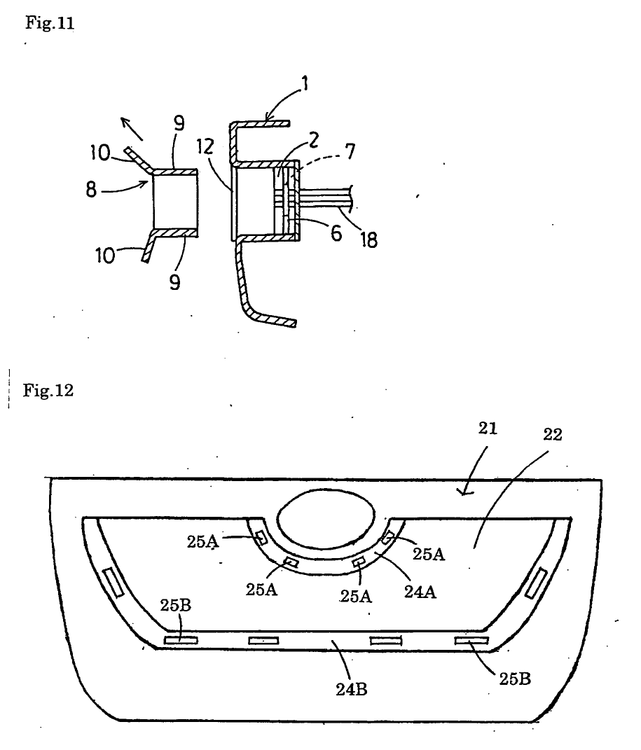

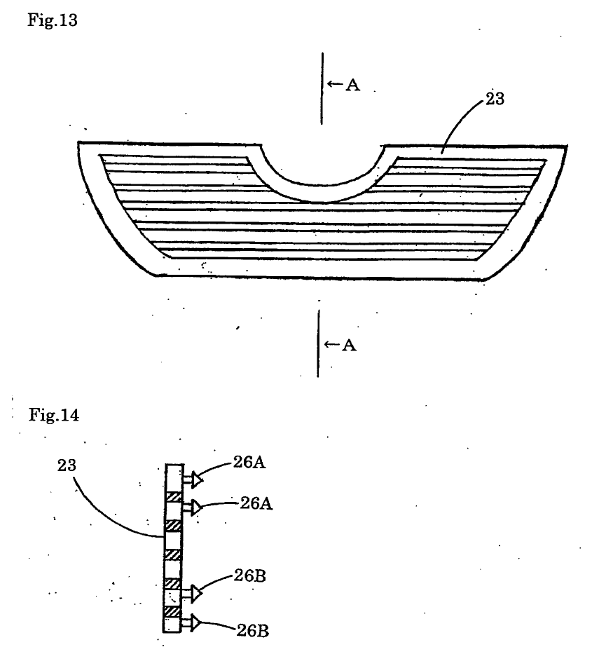

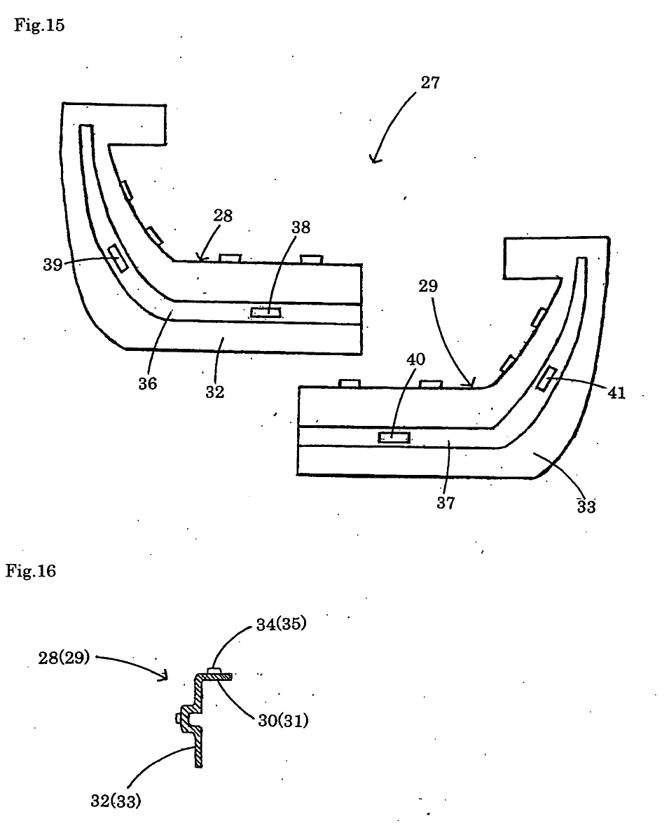

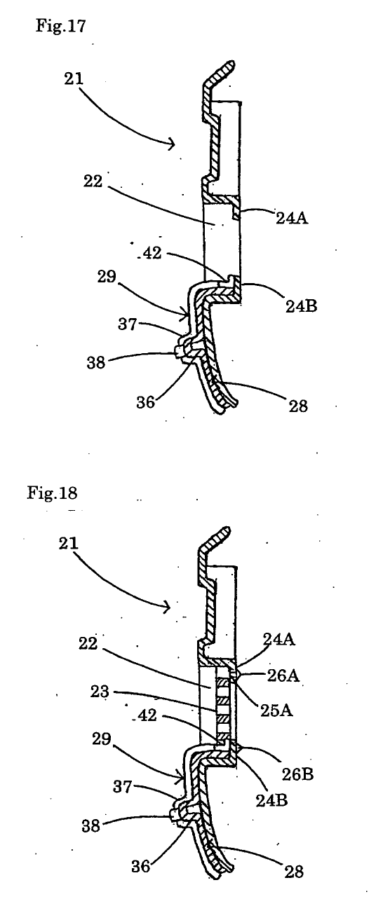

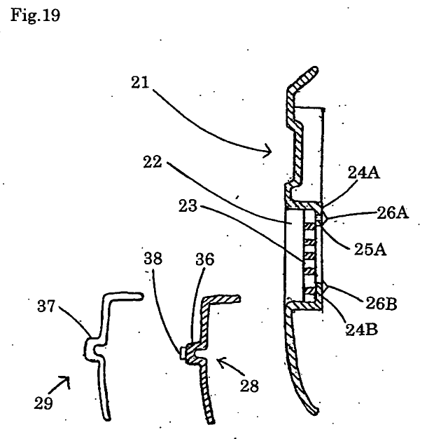

### DESCRIPTION OF NUMBERS

1. Bumper (member)
2. Part fitting hole
3. Protector
8. Hole inner side protective section
10. Surrounding protective section
11. Sheet
12. Lamp housing (part)
18. Harness

1. A protector to protect partially or wholly the surroundings and inside of a part fitting hole of an member in the case of fitting a part thereinto, said protector consisting of a hole inner side protective section which is inserted into the inside of said part fitting hole to protect partially or wholly the inside of said part fitting hole, and a surrounding protective section which covers the outside surroundings of said part fitting hole to protect partially or wholly said surroundings of said part fitting hole, said surrounding protective section integrating with said hole inner side protective section, and further sheet(s) being attached and extended to/from said hole inner side protective section of said protector to protect the inside of said part fitting hole from the harness connecting to said part from the inside of said part fitting hole.

2. A protector in accordance with claim 1, wherein said protector is made of a synthetic resin having a Rockwell hardness of R50 to 150 according to ASTM D785.

3. (canceled)
